(19) United States
(12) Patent Application Publication
(10) Pub. No.: US 2010/0210124 A1
(43) Pub. Date: Aug. 19, 2010

(54) ELECTRICAL CONNECTOR HAVING GROUNDING TERMINAL HAVING TAIL PORTION INTERCONNECTED TO METALLIC SHELL SURROUNDING THE CONNECTOR

(75) Inventor: CAI-FU LI, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/622,443

(22) Filed: Nov. 20, 2009

(30) Foreign Application Priority Data
Feb. 16, 2009 (CN) 200920300642.8

(51) Int. Cl. H01R 13/648

(52) U.S. Cl. 439/108

(57) ABSTRACT

An electrical connector is provided and includes an insulative housing having a main body and a tongue plate with a plurality of terminal grooves extending along a mating direction. A plurality of terminals which are substantially signal terminals and grounding terminals are received in said terminal grooves, each of said terminals has a contacting portion and a tail portion. A metallic shell shields the insulative housing therein. A grounding plate is inserted into said insulative housing and in contact with said metallic shell so as to establish a grounding path between at least one grounding terminal and the metallic shell by a manner of the tail portion of said grounding terminal being electrically connected with said grounding plate.

### BACKGROUND OF THE INVENTION

1. Field of the Invention

The present invention relates to an electrical connector, and more particularly to an electrical connector having a mating interface in which a ground contact is installed, and with a tail portion interconnected to a shell surrounding the connector.

2. Description of the Related Art

U.S. Pat. No. 7,077,668 issued to Lapidot et al. on Jul. 18, 2006 discloses a board mounted electrical connector including signal contacts, grounding contacts and an insulative housing for holding the signal contacts and the grounding contacts. Two rows of the grounding contacts are provided to correspond to at least one pair of the signal contacts at an engagement portion of the insulative housing. Leg portions of the signal contacts and the grounding contacts, to be mounted on a circuit board, are arranged in three rows from a position closest to an engagement surface of the insulative housing to a position farthest from the engagement surface. Therefore, a large space on the circuit board should be prepared for said leg portions to be inserted into, which is not advantage for saving space on the circuit board. Obviously, an improved electrical connector is highly desired to overcome the aforementioned problem.

### SUMMARY OF THE INVENTION

Accordingly, an object of the present invention is to provide an electrical connector which can save the mounting space on a circuit board.

Another object of the present invention is to provide an electrical connector having an improved grounding path.

In order to achieve the object set forth, an electrical connector includes an insulative housing having a main body and a tongue plate with a plurality of terminal grooves extending along a mating direction. A plurality of terminals which are substantially signal terminals and grounding terminals are received in said terminal grooves, each of said terminals has a contacting portion and a tail portion. A metallic shell shields the insulative housing therein. A grounding plate is inserted into said insulative housing and in contact with said metallic shell so as to establish a grounding path between at least one grounding terminal and the metallic shell by a manner of the tail portion of said grounding terminal being electrically connected with said grounding plate.

In order to achieve the object set forth, an electrical connector is provided and includes an insulative housing having a main body defining a plurality of terminal grooves therein. A plurality of terminals are received in said terminal grooves and include signal terminals and grounding terminals with tail portions extending out of the main body. A metallic shell is positioned at an outer circumference of the insulative housing. A grounding plate electrically connects with the metallic shell and at least one grounding terminal. The tail portion of the at least one grounding terminal is configured as a non-solder tail, while the tail portions of the other grounding terminals and signal terminals are configured as solder tails.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the present invention;

FIG. 2 is a front view of the electrical connector shown in FIG. 1;

FIG. 3 is an exploded perspective view of the electrical connector shown in FIG. 1;

FIG. 4 is a partly assembled perspective view from a rear side of the electrical connector shown in FIG. 1;

FIG. 5 is another perspective view of the electrical connector shown in FIG. 1, which is seen from another aspect;

FIG. 6 is a sectional view of the electrical connector, taken along line 6-6 of FIG. 5, which shows a grounding terminal being secured onto an insulative housing;

FIG. 7 is a sectional view of the electrical connector, taken along line 7-7 of FIG. 5, which shows a grounding plate contacting with an exterior shell;

FIG. 8 is a perspective view of a plurality of terminals, three of which are connected with the grounding plate; and

FIG. 9 is another perspective view of the plurality of terminals and grounding plate.

### DETAILED DESCRIPTION OF THE INVENTION

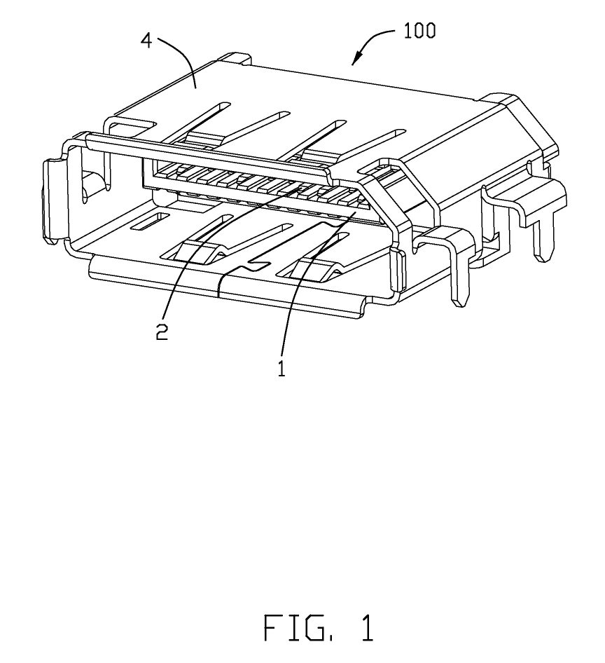

Reference will now be made to the drawing figures to describe a preferred embodiment of the present invention in detail. Referring to FIGS. 1-3, an electrical connector 100 according to the preferred embodiment of the present invention is provided and comprises an insulative housing 1 (hereinafter, simply referred to as “housing”), a plurality of conductive terminals 2 (differential signal transmission terminals and grounding terminals) mounted on the housing 1, a grounding plate 3 contacting with the conductive terminals 2, and a metallic shell 4 shielding the outside of the housing 1. The conductive terminals 2 are arranged into differential pair arrangement, i.e. a pair of signal terminals with one grounding terminal.

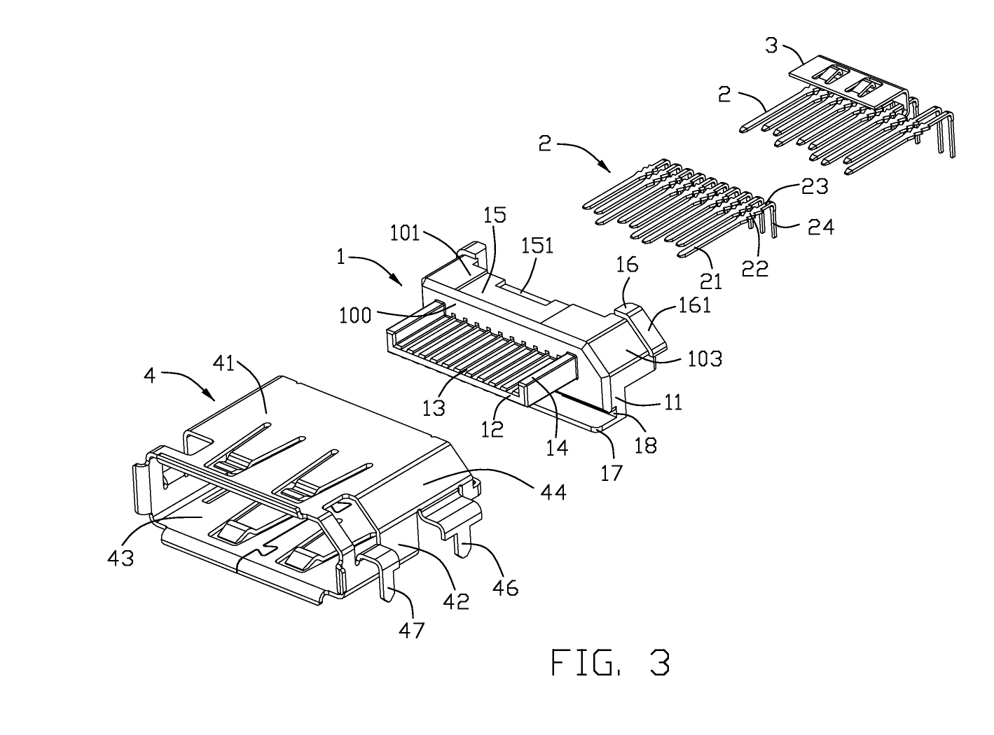

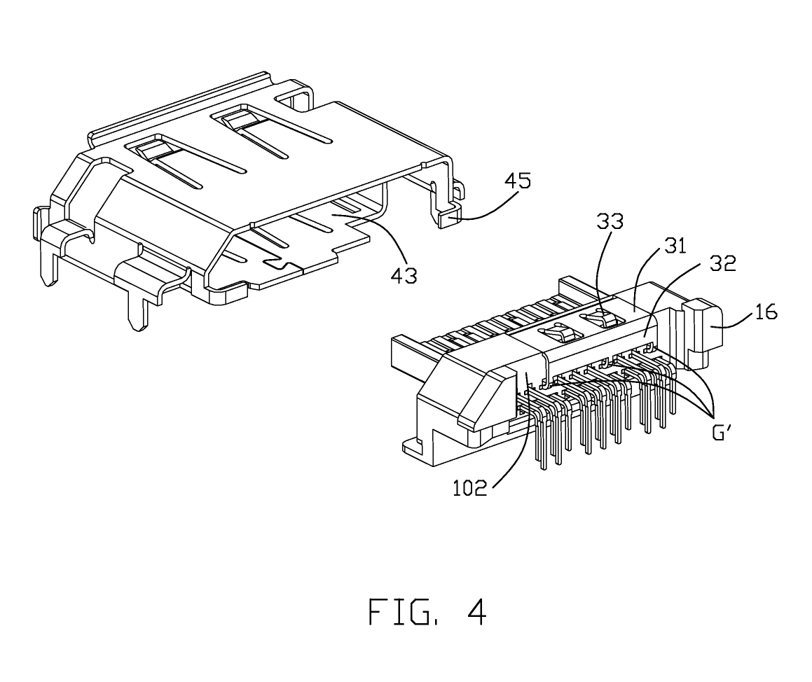

Referring to FIGS. 3 and 4, the housing 1 has a main body 11 and a tongue plate 12 that protrudes forward from a front surface 104 of said main body 11. A plurality of receiving grooves 13 are formed at a predetermined pitch on an upper surface and a lower surface of the tongue plate 12. Said conductive terminals 2 are received in the receiving grooves 13, and each comprises a contacting portion 21 exposed in the tongue plate 12 and a retaining portion 22 secured in the main body 11. The arrangement of the conductive terminals 2 will be described later. A pair of ribs 14 protrude upward from opposite edges of the upper surface of the tongue plate 12 for ensuring an anti-disorientation interengegement. A receiving cavity 15, which is in fact a recess portion, is defined at a rear edge of the upper surface 101 of the main body 11. An aperture 151 is further defined within the receiving cavity 15 and running through a rear surface 102 of the main body 11. A slant surface 103 is formed at one side of the main body 11 and connects with the front surface 104 and upper surface 101, therefore two sides of the main body 11 are in an unsymmetrical configuration. Two protrusions 16 protrude outward from opposite sides of the main body 11 to prevent the rearward movement of the metallic shell 4. A supporting board 17 extends forward from the lower edge of the front surface 104 under the tongue plate 12 and defines a narrow passageway 18 extending along a longitudinal direction. The bottom surface of the rear portion of the main body 11 is at a higher level over the supporting board 17, which can lead the electrical connector 100 to be mounted onto the printed circuit board in a sink type.

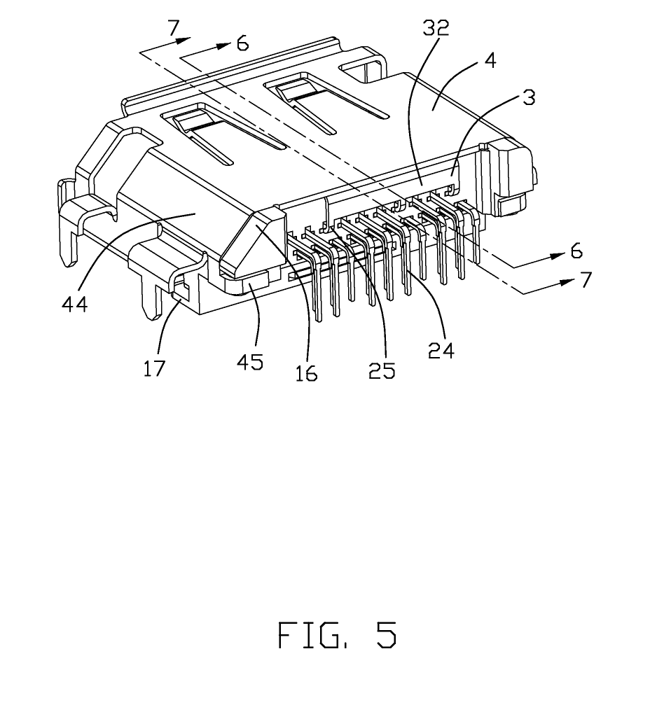

The metallic shell 4 is made by stamping and bending a metal plate. The shell 4 comprises: a top wall 41, which is generally rectangular; side walls 42, which are formed by bending the two lateral edges of the top wall 41 downward; a bottom wall 43, which is formed by bending the side walls 42 inward. Corresponding with the slant surface 103, the shell 4 also forms a guiding wall 44 parallel with the slant surface 103. Combining with FIG. 5, the metallic shell 4 is assembled onto the housing 1 from a front side of the tongue plate 12. The rear edges of the shell 4 abut against the protrusions 16 on the main body 11 for stopping the rearward movement, and the guiding wall 44 is tightly attached onto the slant surface 103, further, the rear edge of the lower wall 43 is inserted into the passageway 18 under the tongue plate 12 for obtaining a retaining force. Moreover, a pair of hook portions 45 which are formed at rear edges of the side walls 42 are bended toward each other so as to hold the housing 1 therein. A pair of first tails 47 and a pair of second tails 46 are respectively formed at front and rear sides of the side walls 42 and extend outwardly and downwardly.

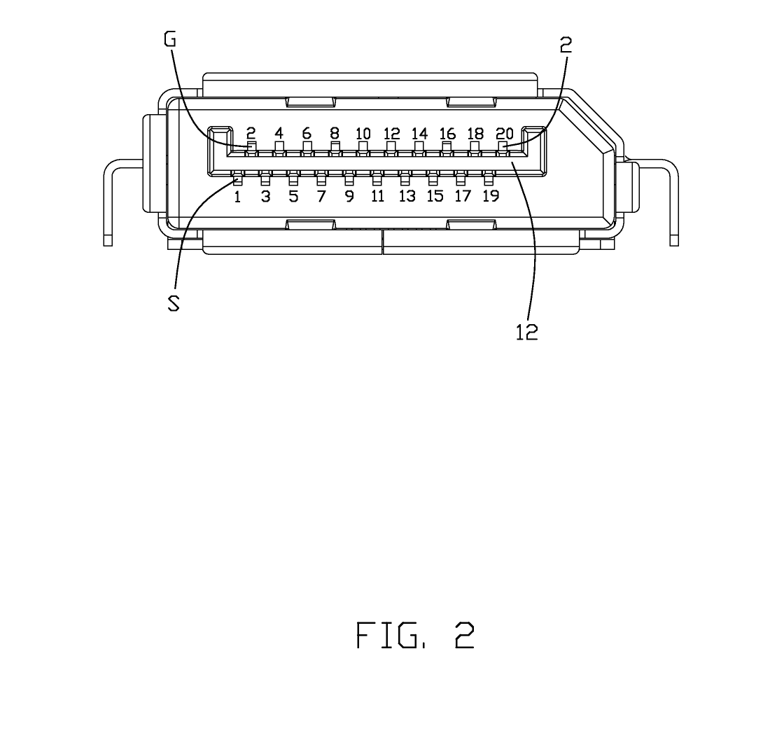

The positions of the contacts 2 illustrated in FIG. 2 have been labeled with consecutive numbers from 1 to 20. The contacts, at positions labeled as 1, 3, 4, 6, 7, 9, 10, 15, 17 are designated as differential signal terminals S, and the contacts, as positions labeled as 2, 5, 8, 11, 13, 14, 16 are designated as grounding terminals G. Every two signal terminals S at one side of the tongue plate together with a grounding terminal G at the opposite side of the tongue plate are grouped as a differential pair, while the grounding terminal G is located right above the middle of the two signal terminals S. Referring to FIG. 4, the terminals of the upper row comprises four grounding terminals G, respectively labeled as 2, 8, 14, 16, wherein three of them (G 2, 8, 16) are connected with the metallic shell 4, and are specially labeled as G′. Each of the grounding terminals G′ comprises a retaining portion 22 and a tail 25 extending rearward from the retaining portion 22, wherein the tail 25 extends upward to contact with the grounding plate 3, while the other terminals of the upper row and the lower row of the terminals form solder tails 24 extending downward for soldering onto the circuit board. That is to say, the terminals 2 of the upper row have two differential tails, the soldering type and the non-soldering type.

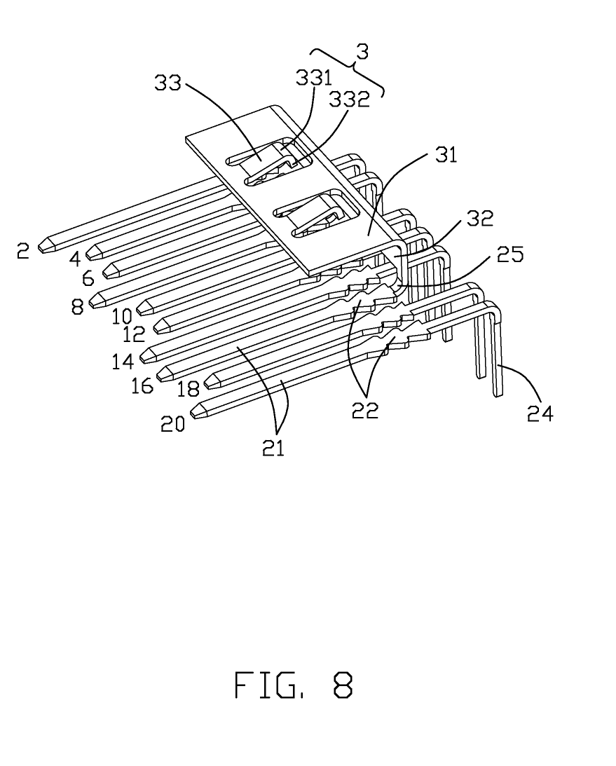

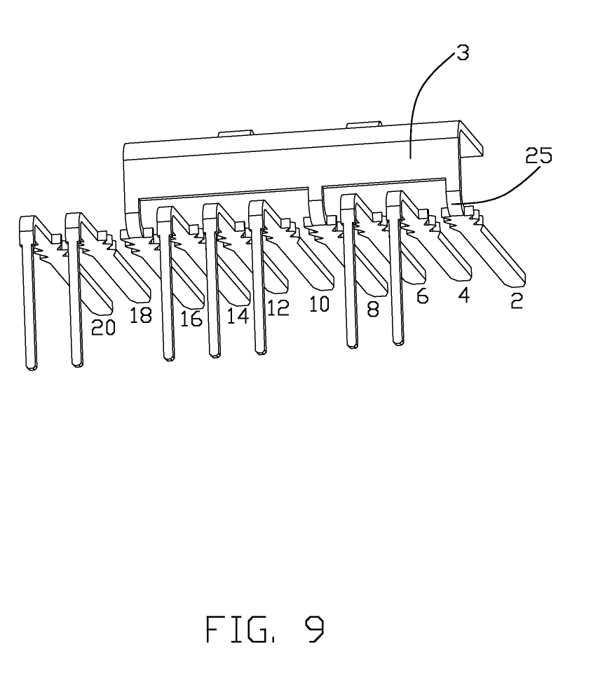

In the present embodiment, the grounding terminals G′ are unitarily formed with the grounding plate 3. Referring to FIGS. 5-9, the grounding plate 3 is made by stamping a metal sheet and bending said metal sheet into a vertical shape. The grounding plate 3 has a flat platform 31 and a vertical portion 32 extending downward from said flat platform 31. A pair of tangs 33 are respectively formed on the flat platform 31 and each has a curved contacting portion 331 on the roof of the tang 33 and a tip end 332 at a lower end of the tang 32. The vertical portion 32 is joined with the tails 25 of the grounding terminals G′, therefore the grounding plate 3 together with the grounding terminals G′ form a clip configuration and insert into said main body 11 in a rear-to-front direction. The flat platform 31 of the grounding plate 3 is snugly engaged with circumference of the receiving cavity 15 to hold the grounding plate 3 on the main body 11.

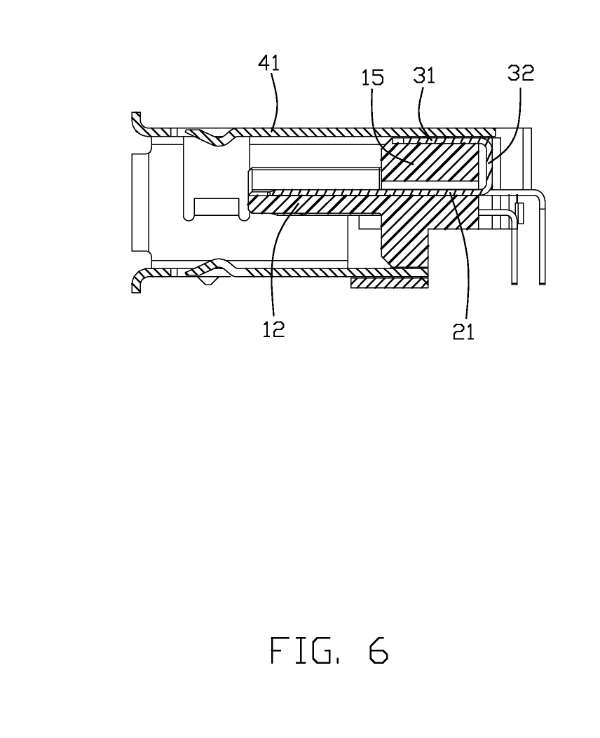

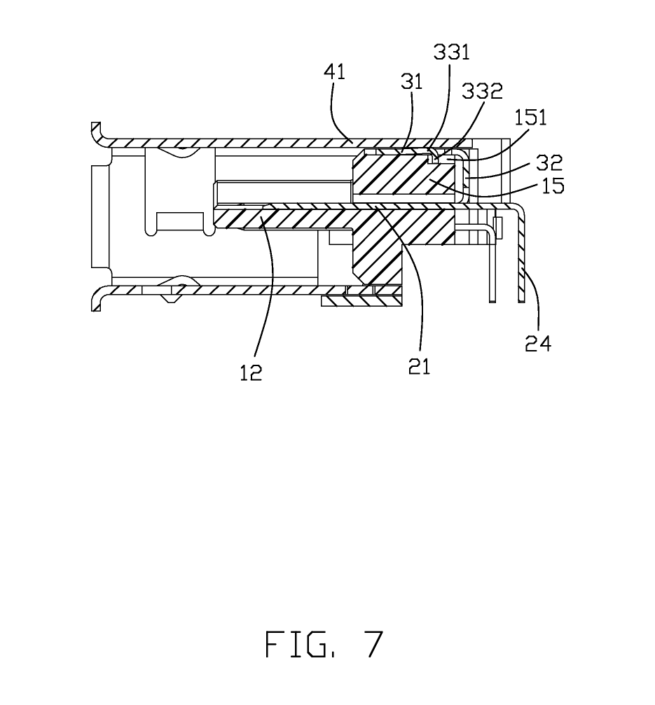

As shown in FIGS. 6 and 7, part of the main body 11 is sandwiched between the flat platform 31 and the contacting portion 21 of the grounding terminals G′, therefore the rigidity of the main body 11 can be strengthened. After the shell 4 is assembled onto the housing 1, the contacting portion 331 of the tang 33 is pressed downwardly by the top wall 41 of the shell 4, and a grounding path through the grounding terminal G′, the grounding plate 3 and the shell 4 is established; meanwhile, the tip end 332 of the tang 33 is pressed fit into the aperture 151 and locked with the main body 11.

In the present invention, the grounding terminals G′ are not directly connected to the circuit board, but through an indirectly path to realize the grounding function, which will not effect the accurate of the signal transmission. As the tails of the grounding terminals G′ extend upward, the other terminals in the upper row with tails extending downward can enjoy a large terminal pitch therebetween, which is helpful for improving the electrical performance of the electrical connector. Moreover, the circuit board on which the electrical connector is mounted can arrange less traces for the solder tails, therefore the space of the electrical connector occupied on the circuit board can be saved.

The grounding plate 3 is unitarily formed with the grounding terminals G′ in the preferred embodiment of the present invention, while the grounding terminals G′ and said grounding plate 3 can be individually formed. More, said grounding terminals G′ can also be arranged at the lower row to contact with the grounding plate 3 under the main body 11.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing having a main body and a tongue plate with a plurality of terminal grooves extending along a mating direction;
a plurality of terminals which are substantially signal terminals and grounding terminals received in said terminal grooves, each of said terminals comprising a contacting portion and a tail portion;
a metallic shell shield the insulative housing therein; and
a grounding plate inserted into said insulative housing and in contact with said metallic shell so as to establish a grounding path between at least one grounding terminal and the metallic shell in a manner of the tail portion of said grounding terminal being electrically connected with said grounding plate.

2. The electrical connector as described in claim 1, wherein the signal terminals and the other grounding terminals have tail portions extending out of the insulative housing for soldering onto a circuit board.

3. The electrical connector as described in claim 1, wherein the at least one terminal is unitarily formed with the grounding plate.

4. The electrical connector as described in claim 3, wherein said grounding plate has a platform retained in a receiving cavity defined on the insulative housing and facing said metallic shell, a pair of tangs project from said platform and press against the metallic shell.

5. The electrical connector as described in claim 4, wherein each tang form a contacting portion pressing against the metallic shell and a tip end pressing fitted in an aperture defined in receiving cavity so as to obtain an interfering force.

6. The electrical connector as described in claim 1, wherein the contacting portions of the terminals are respectively located at an upper surface and a lower surface of the tongue plate, accordingly, the tail portions are positioned as an upper row and a lower row, and the at least one grounding terminal is located at the upper row with tail portion extending reversely relative to the tail portions of other terminals.

7. The electrical connector as described in claim 6, wherein the metallic shell comprises a top wall, a bottom wall shorter than the top wall in the mating direction and two side walls connecting the top and bottom walls, a passageway is defined on the main body under the tongue plate for receiving said bottom wall.

8. The electrical connector as described in claim 7, wherein a slant wall is formed at one side of the metallic shell between the side wall and the top wall to ensure an anti-disorientation interengegement, and a pair of hook portions formed on the side wall are bended inwardly to maintain the metallic shell on the insulative housing after the metallic shell is assembled onto the insulative housing.

9. The electrical connector as described in claim 8, wherein a rear portion of the main body is located higher than the bottom wall of the metallic shell, therefore the electrical connector is in a sink type.

10. An electrical connector comprising:
an insulative housing having a main body defining a plurality of terminal grooves therein;
a plurality of terminals received in said terminal grooves and comprising signal terminals and grounding terminals with tail portions extending out of the main body;
a metallic shell positioned at an outer circumference of the insulative housing; and
a grounding plate electrically connecting with the metallic shell and at least one grounding terminal;
wherein the tail portion of the at least one grounding terminal is configured as a non-board mounting type, while the tail portions of the other grounding terminals and signal terminals are configured as a board mounting type.

11. The electrical connector as described in claim 10, wherein the non-board mounting type tail is unitarily formed with the grounding plate and attached to the insulative housing, while the board mounting type tails project outward for being soldered onto a circuit board.

12. The electrical connector as described in claim 11, wherein the grounding plate is embedded in an upper wall of the main body and defines a pair of flexible tangs projecting outward to press against the metallic shell.

13. The electrical connector as described in claim 12, wherein the tail portions of the terminals are arranged into an upper row and a lower row, said non-board mounting type are grounding terminals and located at the upper row together with the other solder type terminals.

14. The electrical connector as described in claim 10, wherein the tail portions of the board mounting type have differential terminal intervals therebetween.

15. An electrical connector, comprising:
an insulative housing with a mating tongue extending therefrom and defined with a plurality of grooves;
a metallic shell substantially enclosing the mating tongue;
a plurality of contact terminals disposed within some of the grooves; and
a ground tab having contact engaging portions inserted into the grooves and a base portion interconnecting with the metallic shell.

16. The electrical connector as described in claim 15, wherein the base portion of the ground tab is sandwiched between the insulative housing and the metallic shell.

17. The electrical connector as described in claim 15, wherein said contact engaging portions are intermingled with said contact terminals in a transverse direction and in a coplanar manner under condition that a pitch between every neighboring two of a combination of said intermingled contact engaging portions and the contact terminal along said transverse direction is constant.

18. The electrical connector as claimed in claim 17, wherein the contact terminals are equipped with board mounting tails for mounting to a printed circuit board while the grounding is not under condition that the base portion and said board mounting tails are located by two sides of the contact engaging portions in a vertical direction perpendicular to said transverse direction.

19. The electrical connector as claimed in claim 18, wherein said base portion is essentially located in front of said board mounting tails in a front-to-back direction perpendicular to both said transverse direction and said vertical direction.

20. The electrical connector as claimed in claim 15, wherein both said contact terminals and said contact engaging portions have barbs thereon to interfere within the corresponding grooves, respectively, and said base portion is essentially located above and aligned with said barbs in said vertical direction.
